(19) United States
(12) Patent Application Publication
(10) Pub. No.: US 2012/0004953 A1
(43) Pub. Date: Jan. 5, 2012

(54) VOTING SYSTEM

(76) Inventor: Paul Comito, Des Moines, IA (US)

(21) Appl. No.: 12/827,163

(22) Filed: Jun. 30, 2010

(51) Int. Cl. G06Q 10/00; G06F 15/16

(52) U.S. Cl. 705/12; 709/204

(57) ABSTRACT

A voting system having a controller connected to a plurality of voting stations and a public display. The controller stores, edits, and displays resolutions that are voted on. The controller also records, tallies and displays the results of the votes.

### BACKGROUND OF THE INVENTION

This invention is directed to a voting system and more particularly to a voting system that improves the efficiency of municipality voting.

Presently, for board meetings and municipalities, much time is spent going from one member to the next to record their vote. Additional time is needed to record, tabulate, and report the results of each vote. As a result, less time is available for discussion of issues and resolutions. Therefore a need exists in the art for a voting system that addresses these deficiencies.

An objective of the present invention is to provide a more efficient voting system.

A further objective of the present invention is to provide a better way of recording and reporting voting results.

These and other objectives will be apparent to one of skill in the art based upon the following disclosure.

### SUMMARY OF THE INVENTION

A voting system having a controller connected to a plurality of voting stations and a public display. The controller stores, edits, and displays resolutions that are voted on. The controller also records, tallies and displays the results of the votes.

### BRIEF DESCRIPTION OF THE DRAWINGS

FIG. 1 is a schematic drawing of the environment of a voting system; and

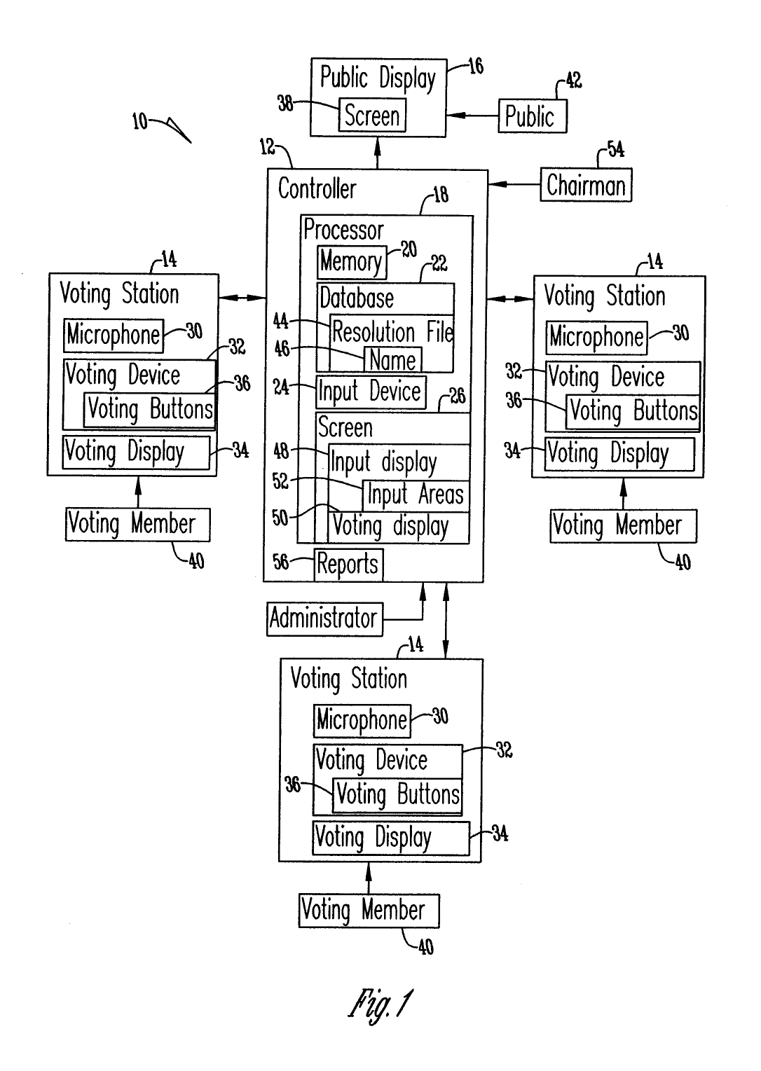

FIG. 2 is a flow diagram for a voting system.

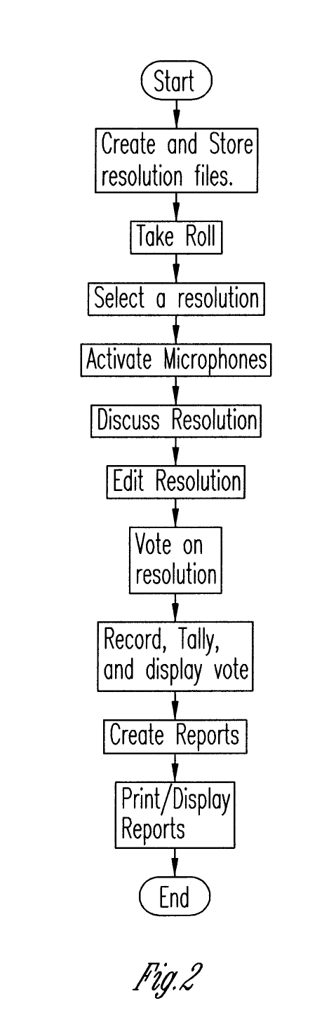

### DETAILED DESCRIPTION OF THE PREFERRED EMBODIMENTS

Referring to the Figures, the voting system 10 includes a controller 12 that is electronically or wirelessly attached to a plurality of voting stations 14 and a display 16. The controller 12 includes a processor 18, memory 20, database 22, input device 24 such as a keyboard and a screen 26. Typically, the controller 12 is operated by an administrator 28.

The voting stations 14 have a microphone 30, a voting device 32, and a voting display 34. The voting device 32 is of any type but preferably has voting buttons 36 where one button is for yes, one is for no, and one is for abstain.

The display 16 includes a screen 38 that permits voting members 40 and the public 42 to view voting results.

In operation, a resolution file 44 is created which includes a plurality of issues to be voted on. Each resolution is provided a name 46 and a time stamp of when the resolution was created. The resolution file 44 is either input or downloaded to the database 22 of the controller 12. Initially, when a meeting begins, shown on the controller screen 26 is a double display which includes an input display 48 and a voting display 50. The input display 48 includes input areas 52 where the names of the board members 40 and chairman 54 may be input, edited, and changed. The voting display 50, which is shown on each voting display 34 and the public screen 38, shows the names of the voting members 40 and chairman 54 preferably as they are seated in the voting room.

First roll is taken where the administrator 28 inputs the presence or absence of each voting member 40 and chairman 54 which is then shown on each voting display 34 and the public screen 38 either by color or indicia.

Once roll is taken a resolution is selected by the administrator 28 from the resolution file 44 and either the name of the resolution, the resolution itself, or both are shown on voting display 34 and/or public screen 38. Discussion then occurs and either the resolution is voted on, changes are made to the resolution, or a portion of the resolution is voted on. If changes are made to the resolution or just a portion is voted on the administrator 28 edits the name 46 and/or the resolution and the revised resolution is time stamped and saved in the database 22. For discussion the administrator 28, through the controller 12, activates the microphones 30 of the voting stations 14. In one embodiment a timer is set for the microphone to shut off activation when a predetermined time elapses. The administrator 28 activates all microphones 30, just the voting member 40 speaking, or all voting members 40 present. The administrator 28 may also designate some microphones, such as the chairman's 54, to remain on at all times.

Once discussion is closed a vote is taken. Each voting member 40 places their vote by activating a voting button 36 corresponding with their vote. A signal is sent from the voting device 32 to the controller 12 where the vote is recorded, tallied, and displayed. When displayed, each voting member's 40 vote is shown on screen 34 and 38 either in color or by indicia and a tally is also shown. If there is a tie, then the chairman 54 votes in the same manner.

From the votes, reports 56 are created by the processor 18. The reports include, but are not limited to, historic voting of each voting member 40, the vote for each resolution, and votes for each meeting. In addition, the meeting may be recorded and stored by the controller 12. Minutes of the meeting may be input and stored in the database 22.

Accordingly, a voting system has been shown that, at the very least, meets all the stated objectives.

1. A voting system, comprising:
a controller connected to a plurality of voting stations; wherein the controller has a screen with a double display which includes an input display and a voting display; and
wherein the voting stations have a microphone activated by the controller, a voting device and a display for showing the voting display.

2. The system of claim 1 further comprising a public display connected to the controller.

3. The voting system of claim 1 wherein the controller has a plurality of resolution files stored in a database in the controller.

4. The system of claim 3 wherein the resolution files are edited through the input display.

5. The system of claim 1 wherein votes are recorded, tallied, and displayed by the controller.

6. The system of claim 1 wherein the controller activates microphones on the voting stations.

7. The system of claim 1 wherein the voting display displays names of voting members as they are seated in a voting room.

8. The system of claim 7 wherein the voting display shows the presence or absence of each voting member.

9. The system of claim 8 wherein the input display includes input areas where the names of the voting members may be input, edited, and changed.

10. The system of claim 1 wherein the voting device has voting buttons wherein one voting button is for “yes”, another voting button is for “no”, and another voting button is for “abstain”.

11. A voting system, comprising:
a controller connected to a plurality of voting stations wherein the controller has a screen with a double display which includes an input display and a voting display;
a public screen connected to the controller that permits voting members and members of the public to view voting results;
wherein the input display includes input areas where the names of the voting members may be input, edited, and changed and the voting display displays names of voting members as they are seated in a voting room; and
wherein the voting stations have a microphone, a voting device and a display for showing the voting display.

12. The system of claim 11 wherein the voting display is shown on the public screen.

13. The system of claim 12 wherein each voting member's vote is shown on the public screen.

14. The system of claim 11 wherein the controller activates the microphones on the voting stations and a timer is set to shut off activation when a predetermined time elapses.
